(19) United States
(12) Patent Application Publication
(10) Pub. No.: US 2023/0322571 A1
(43) Pub. Date: Oct. 12, 2023

(54) METAL OXIDE NANOMATERIALS

(71) Applicant: UNIVERSITY OF CONNECTICUT, Farmington, CT (US)

(72) Inventors: Steven L. Suib, Farmington, CT (US); Shubhashish Shubhashish, Farmington, CT (US)

(21) Appl. No.: 18/133,366

(22) Filed: Apr. 11, 2023

Related U.S. Application Data
(60) Provisional application No. 63/329,719, filed on Apr. 11, 2022.

(51) Int. Cl. C01F 5/06; B01J 6/00; B01J 37/00; B01J 35/02; B01J 35/10; B01J 21/10

(52) U.S. Cl. CPC C01F 5/06; B01J 6/001; B01J 37/0072; B01J 35/026; B82Y 30/00; B01J 35/1038; B01J 35/1014; B01J 21/10; B01J 35/1061

(57) ABSTRACT

Methods for synthesizing and using metal oxide nanomaterials are provided. The methods include heating a solution including large inverse micelles of a metal chelate in a solvent to a temperature greater than the solvent boiling point to form a dried product and calcining the dried product to form the metal oxide nanomaterial.

### CROSS-REFERENCE TO RELATED APPLICATIONS

This application claims the benefit of U.S. Provisional Application No. 63/329,719, filed Apr. 11, 2022, the content of which is herein incorporated by reference in its entirety.

### STATEMENT REGARDING FEDERALLY SPONSORED RESEARCH OR DEVELOPMENT

This invention was made with government support under DE-FG02-86ER13622 awarded by the U.S. Department of Energy. The government has certain rights in the invention.

### FIELD

The present disclosure relates to methods for synthesizing and using metal oxide nanomaterials.

### BACKGROUND

A variety of materials that exhibit some degree of porosity are important for applications in optics, catalysis, drug delivery systems, coatings, cosmetics, bio-separation, diagnostics, gas-separation, and nanotechnology. Nanoporous materials generally fall under three major categories: microporous, mesoporous, and macroporous. Porous materials which have pore diameters in between 2 nm to 50 nm are known as “mesoporous materials.” Based on pore size, such materials can be divided into two classes; small pore diameter (<10 nm) and large pore diameter (>10 nm) mesoporous materials.

Template-assisted methods are generally employed to prepare porous metal oxides. However, template-assisted method is commonly operated in wet conditions, which requires solvents, soluble metal oxide precursors and a long time for drying. Comparatively, materials having small pore diameters are easy to synthesize and therefore are very common, whereas larger pore diameter materials are more challenging to produce. Recently, various methods have been used to synthesize large pore diameter mesoporous materials. Given far fewer hard templates and complex requirements, soft templating methods most often have been used to synthesize large pore diameter materials. To form large pores, larger micelle formation which promotes further self-assembly to form thermodynamically stable long range structures is required. However, conventional methods of synthesis which facilitate large micelle formation are either limited to a specific metal or expensive due to complex and time-consuming processes. Thus, a well-developed general synthesis method for large pore mesoporous materials is needed.

### SUMMARY

Disclosed herein are methods for synthesizing metal oxide nanomaterials. In some embodiments, the methods include heating a solution including large inverse micelles of a metal chelate in a solvent to a temperature greater than the solvent boiling point to form a dried product and calcining the dried product to form the metal oxide nanomaterial.

In some embodiments, heating the solution includes increasing the temperature of the solution at a rate of about 1° C./min.

In some embodiments, the calcining includes increasing the temperature of the dried product at a rate of about 5° C./min until a final calcination temperature is reached. In some embodiments, the final calcination temperature is greater than about 250° C. In some embodiments, the final calcination temperature is at least about 350° C. In some embodiments, the final calcination temperature is between about 350° C. and about 500° C.

In some embodiments, the calcining step is carried out for about 1 to about 10 hours. In some embodiments, the calcining step is carried out for about 3 hours.

In some embodiments, the methods further include preparing the solution including large inverse micelles of a metal chelate in a solvent.

In some embodiments, preparing the solution includes mixing the solvent with a metal precursor to form a metal chelate solution and adding a surfactant to the metal chelate solution.

In some embodiments, the solution further includes adding an acid to the metal chelate solution. In some embodiments, the acid includes nitric acid.

In some embodiments, preparing the solution is carried out at less than about 100° C. In some embodiments, preparing the solution is carried out at room temperature.

In some embodiments, the metal is magnesium, calcium, vanadium, nickel, zinc, zirconium, hafnium, tin, lanthanum, or cerium.

In some embodiments, the metal precursor includes a metal oxide, a metal nitrate, or a metal chloride. In some embodiments, the metal precursor is selected from magnesium oxide, calcium nitrate, vanadium oxide, nickel nitrate, zinc nitrate, zirconium oxide, hafnium chloride, tin chloride, lanthanum oxide, and cerium nitrate.

In some embodiments, the solvent is a diol. In some embodiments, the diol is ethanediol, a propanediol, a butanediol, a pentanediol, or a combination thereof. In some embodiments, the solvent includes one or more of: ethylene glycol, 1,3 propanediol, 1,4 butanediol, 1,5 pentane diol.

In some embodiments, the solvent is ethylene glycol and the metal precursor is magnesium oxide.

In some embodiments, the surfactant includes an amphiphilic block copolymer.

In some embodiments, the metal oxide nanomaterial has pores with average diameters between about 2 and about 50 nm. Thus, in some embodiments, the metal oxide nanomaterial is mesoporous. In some embodiments, the metal oxide nanomaterial has pores with average diameters greater than about 10 nm. In some embodiments, the metal oxide nanomaterial is a large pore diameter mesoporous material.

In some embodiments, the metal oxide nanomaterial has pores with total volumes greater than about 0.1 cc/g. In some embodiments, the metal oxide nanomaterial has pores with total volumes greater than about 1 cc/g.

In some embodiments, the metal oxide nanomaterial has a surface area between about 10 and 200 m²/g. In some embodiments, the metal oxide nanomaterial has a surface area greater than about 50 m²/g.

Also disclosed herein are metal oxide nanomaterials. In some embodiments, the metal oxide nanomaterials include at least one metal oxide formed by calcining a chelate of at least one metal precursor.

In some embodiments, the metal oxide nanomaterials have: pores with average diameters greater than about 2 nm; pores with total volumes greater than about 0.1 cc/g; surface area greater than 10 m²/g; or a combination thereof. In some embodiments, the nanomaterial has pores with average diameters greater than about 10 nm. In some embodiments, the nanomaterial has pores with total volumes greater than about 1 cc/g. In some embodiments, the nanomaterial has a surface area greater than about 50 m²/g.

In some embodiments, the metal is magnesium, calcium, vanadium, nickel, zinc, zirconium, hafnium, tin, lanthanum, or cerium.

Also disclosed herein are metal oxide nanomaterials synthesized by the methods disclosed herein.

Further disclosed are mesoporous magnesium oxide nanomaterials having a surface area greater than 150 m²/g and pores with average diameters greater than 30 nm, wherein the pores have total volumes greater than 1.0 cc/g.

Further disclosed herein are systems or devices having: a sorption unit and a metal oxide nanomaterial as disclosed herein disposed within the sorption unit.

Additionally disclosed are methods of adsorbing, separating, storing, or sequestering carbon dioxide, including contacting the metal oxide nanomaterial or a system or device as disclosed herein with an input gas stream containing a first component and carbon dioxide to form a resulting gas stream with a lower amount of carbon dioxide than the input gas stream.

In some embodiments, the methods further include desorbing at least a portion of the adsorbed carbon dioxide to form a desorbed carbon dioxide portion.

In some embodiments, the input gas is natural gas, ambient air, environmental control air, flue gas, or other impure gas mixtures containing carbon dioxide.

In some embodiments, the methods further include removing particulate matter from the input gas prior to contacting with the metal oxide nanomaterial or system or device.

Additionally disclosed are methods of adsorbing, separating, storing, or sequestering a molecule including contacting the metal oxide nanomaterial or a system or device as disclosed herein with a sample including the molecule. In some embodiments, the molecule is a macromolecule, a small molecule therapeutic or prophylactic, or contaminant. In some embodiments, the sample is a gas sample or a liquid sample.

Additionally disclosed are methods for delivering a cargo molecule to a cell, tissue, or subject in need including administering to a subject a composition or device including the metal oxide nanomaterial disclosed herein and the cargo molecule. In some embodiments, the cargo molecule is a therapeutic or prophylactic agent, an imaging agent, or a diagnostic agent. In some embodiments, the therapeutic agent is a nucleic acid, a protein, a carbohydrate, or a small molecule.

Other aspects and embodiments of the disclosure will be apparent in light of the following detailed description and accompanying figures.

### BRIEF DESCRIPTION OF THE DRAWINGS

FIG. 1 is a schematic of an exemplary synthesis procedure for mesoporous metal oxides.

FIGS. 2A-2F are wide-angle powder X-ray diffraction (PXRD) patterns of mesoporous metal oxides: synthesized and commercial magnesium oxide (FIG. 2A); magnesium oxide via different diols synthesis (FIG. 2B); nickel oxide (FIG. 2C); zinc oxide (FIG. 2D); tin (IV) oxide (FIG. 2E); and lanthanum (III) oxide (FIG. 2F). Indexed peaks displaying mesoporous metal oxide phases.

FIGS. 3A and 3B are N2-sorption isotherm (FIG. 3A) and Barrett—Joyner—Halenda (BJH) desorption pore size distribution (FIG. 3B) for: *C₂—O—SS—Mg-350-3 h, *C₃—O—SS—Mg-350-3 h, *C₄—O—SS—Mg-350-3 h, *C₅—O—SS—Mg-350-3 h, *C₆—O—SS—Mg-350-3 h, and *C₁₂—O—SS—Mg-450-3 h (Top to bottom). FIGS. 3C and 3D are N2-sorption isotherm (FIG. 3C) and BJH desorption pore size distribution (FIG. 3D) for room temperature catalyst synthesis with different calcination. FIGS. 3E and 3F Are N2-sorption isotherm (FIG. 3E) and BJH desorption pore size distribution (FIG. 3F) of C₂—O—SS—La at different calcination temperatures.

FIGS. 4A-4D are transmission electron microscopy (TEM) Image of C₂—O—SS—Mg-350-3 h in which FIG. 4A shows SAED, FIG. 4B reveals Nanoparticle behavior, FIG. 4C is manifest crystalline nature, and FIG. 4D denotes zoomed image with d spacing and lattice plane.

FIGS. 5A-5D are transmission electron microscopy (TEM) Image of C₂—N—SS—Ni-450-3 h in which FIG. 5A shows SAED, FIG. 5B reveals Nanoparticle behavior, FIG. 5C is manifest crystalline nature, and FIG. 5D denotes zoomed image with d spacing and lattice plane.

FIGS. 6A-6D are transmission electron microscopy (TEM) Image of C₂—N—SS—Zn-450-3 h in which FIG. 6A shows SAED, FIG. 6B reveals Nanoparticle behavior, FIG. 6C is manifest crystalline nature, and FIG. 6D denotes zoomed image with d spacing and lattice plane.

FIGS. 7A-7D are transmission electron microscopy (TEM) Image of C₂-C₁—SS—Sn-450-3 h in which FIG. 7A shows SAED, FIG. 7B reveals Nanoparticle behavior, FIG. 7C is manifest crystalline nature, and FIG. 7D denotes zoomed image with d spacing and lattice plane.

FIGS. 8A-8F show XPS analysis of mesoporous metal oxides: Mg-2p deconvoluted spectra of magnesium oxides (FIG. 8A); O 1 s deconvoluted spectra of magnesium oxides (FIG. 8B); Ni 2p deconvoluted spectra of NiO (FIG. 8C); O 1 s deconvoluted spectra of NiO (FIG. 8D); La 3d deconvoluted spectra of La₂O₃ (FIG. 8E); and O 1 s deconvoluted spectra of La₂O₃ (FIG. 8F).

FIGS. 9A-9D show CO₂ adsorption-desorption analysis of C₂—O—SS—Mg-350-3 h at 0° C. and 25° C. along with commercial magnesium oxide at 0° C. (FIG. 9A) and C₂—O—SS—La-350-3 h and C₂—O—SS—La-450-3 h at 0° C. (FIG. 9C) and CO₂ adsorption capacity for C₂—O—SS—Mg-350-3 h at 0° C. and 25° C. along with commercial magnesium oxide at 0° C. (FIG. 9B) and C₀₂ adsorption capacity for C₂—O—SS—La-350-3 h and C₂—O—SS—La-450-3 h at 0° C. (FIG. 9D).

FIGS. 10A-10D show sorption studies of C₂—O—SS—Mg-350-3 h UV-visible spectroscopy of SSBP with and without adsorbent (FIG. 10A); UV-visible spectroscopy of Oleic acid with and without adsorbent (FIG. 10B); UV-visible spectroscopy of curcumin: in catalyst, with and without commercial MgO (FIG. 10C); and Infrared spectroscopy of dopamine, 1:1 mixture of dopamine and adsorbent, and adsorbent (FIG. 10D).

### DETAILED DESCRIPTION

Disclosed herein are methods for fabrication of metal oxide nanomaterials. Advantageously, the techniques do not require catalysts washing or drying in a vacuum oven. Thus, the techniques result in cost effective and efficient production of large pore diameter mesoporous metal oxide nanomaterials. The techniques disclosed may be applied to a variety of metal oxides, including metal oxides formed from metals belonging to the s-block, p-block, d-block, or f-block of the Periodic Table of the Elements.

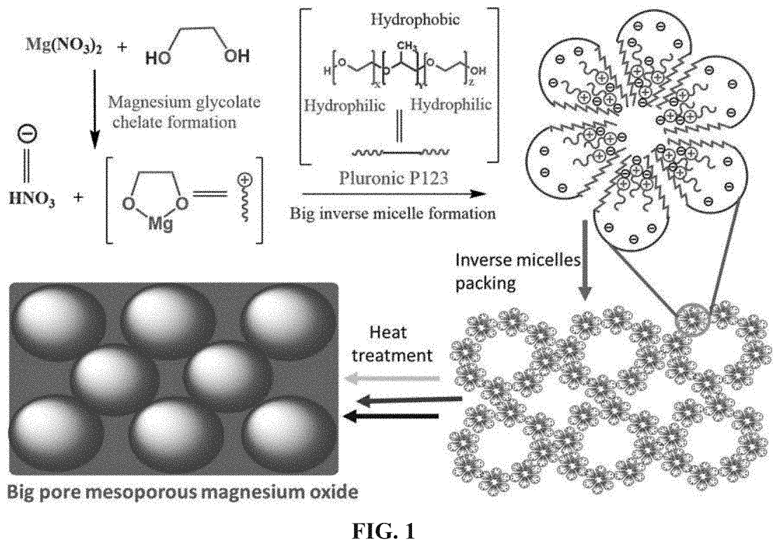

Generally, the large pore diameter mesoporous metal oxide nanomaterials are synthesized according to a procedure, aspects of which are set forth in FIG. 1. Ethylene glycol and other diols are used as solvent as well as a precursor modifier to form a metal chelate. Due to metal chelate formation, the size of the resulting inverse micelles is large which upon heating, leads to oxidation of the metal chelate to metal oxides and formation of a nanomaterial having larger sized pores.

Various large pore diameter mesoporous magnesium oxide nanomaterials fabricated by the disclosed methods were tested for potential applications in molecular adsorption. Magnesium and lanthanum based nanomaterials showed utility for CO₂ capture and small therapeutic molecule adsorption. Additionally, the resulting large pore diameter magnesium oxide nanomaterials can be used as catalysts in reactions where higher molecular weight reactants and products are involved. Larger pore diameters and pore volumes of the nanomaterials synthesized herein conferred enhanced properties in comparison to commercial oxides.

### 1. Metal Oxide Nanomaterials

The present disclosure provides methods for synthesizing a metal oxide nanomaterial. As a result of the technology presented in this disclosure, large pore diameter mesoporous metal oxide nanomaterials that confer enhanced sorptive, conductive, structural, catalytic, magnetic, and/or optical properties can be prepared.

As used herein, a “nanomaterial” generally has at least one dimension of about 300 nm or smaller. Examples of nanomaterials include nanoparticles (which can have irregular or regular geometries), nanospheres, nanowires (which are characterized by a large aspect ratio), nanoribbons (which has a flat ribbon-like geometry and a large aspect ratio), nanorods (which typically have smaller aspect ratios than nanowires), nanotubes, and nanosheets (which has a flat ribbon-like geometry and a small aspect ratio). Thus, the metal oxide nanomaterial can be selected from a metal oxide nanoparticle, a metal oxide nanosphere, a metal oxide nanowire, a metal oxide nanoribbon, a metal oxide nanorod, a metal oxide nanotube, a metal oxide nanosheet, and combinations thereof. In some embodiments, the metal oxide nanomaterial at least partially includes metal oxide nanoparticles.

The metal can include any known metal, including, for example, an alkali metal, an alkaline earth metal, a transition metal, a lanthanide, an actinide, or a metalloid. In some embodiments, the metal may be a s-block element, a p-block element, a d-block element, or an f-block element as organized in the Periodic Table of the Elements. In some embodiments, the metal is magnesium, calcium, vanadium, nickel, zinc, zirconium, hafnium, tin, lanthanum, or cerium.

The methods are also suitable for use with multiple metals. For example, to form a mixed metal material comprising two or more metals. As such, each of the individual metals may be independently an alkali metal, an alkaline earth metal, a transition metal, a lanthanide, an actinide, or a metalloid. In some embodiments, each of the two or more metals is magnesium, calcium, vanadium, nickel, zinc, zirconium, hafnium, tin, lanthanum, or cerium.

The methods include heating a solution including large inverse micelles of a metal chelate in a solvent to a temperature greater than the solvent boiling point to form a dried product and calcining the dried product to form the metal oxide nanomaterial.

In some embodiments, the heating includes increasing the temperature of the solution at a rate of about 1° C./min. The slow increase in temperature allows for solvent evaporation to occur at a slower rate.

In some embodiments, the calcining step includes increasing the temperature of the dried product at a rate of about 5° C./min until a final calcination temperature is reached. The final calcination temperature is any temperature which facilitates metal chelate dissociation and conversion of the metal to a metal oxide. As such, “calcining” refers to heating of the dried, solvent evaporated, product to a temperature and for a period of time at which the metal chelate dissociates, the surfactant is removed, and the metal is converted to a metal oxide. Additionally, the calcining may further result in additional packing of the solid nanomaterials over that in the dried product.

In some embodiments, the final calcination temperature is greater than about 250° C. (e.g., about 275° C., about 300° C., about 325° C., about 350° C., about 375° C., about 400° C., about 425° C., about 450° C., about 475° C., about 500° C., about 525° C., about 550° C., about 575° C., about 600° C. or more). In select embodiments, the final calcination temperature is at least about 350° C. In select embodiments, the final calcination temperature is between about 350° C. and about 500° C. For example, the final calcination temperature may be between about 350° C. and about 400° C., about 350° C. and about 450° C., about 350° C. and about 500° C. about 400° C. and about 450° C., about 400° C. and about 500° C., or about 450° C. and about 500° C.

The calcining step may be carried out for any period of time which facilitates metal oxide formation and solid packing of the nanomaterials. In some embodiments, the calcining step is carried out for about 1 to about 10 hours (e.g., about 1 hour, about 2 hours, about 3 hours, about 4 hours, about 5 hours, about 6 hours, about 7 hours, about 8 hours, about 9 hours, or about 10 hours). In select embodiments, the calcining step is carried out for about 3 hours including or following the time to reach the final calcination temperature.

In some embodiments, the methods further include preparing the solution including large inverse micelles of a metal chelate in a solvent. Any method may be used to prepare the solution of large inverse micelles of a metal chelate. In some embodiments, the solution is prepared by mixing the solvent with a metal precursor to form a metal chelate solution and adding a surfactant to the metal chelate solution.

Preparing the large inverse micelle solution may include agitation, e.g., the solution may be shaken, stirred, swirled, sonicated, or otherwise agitated. The agitating may be vigorous, moderate, or mild. The resulting large inverse micelle solution may be a solution, a microemulsion, an emulsion, a dispersion, or some other type of mixture.

Preparing the large inverse micelle solution may be carried out at a variety of temperatures. In some embodiments, the temperature of the preparation is less than about 100° C. For example, the temperature of the preparation may be about 90° C., about 80° C., about 70° C., about 60° C., about 50° C., about 40° C., about 30° C., about 20° C., about 10° C., or lower. In some embodiments, the temperature of the preparation is between 20° C. and 30° C., e.g., between 20° C. and 25° C. or between 25° C. and 30° C. In some embodiments, the temperature of the preparation is room temperature, or about 20 to 23° C.

The preparation of the solution may further include, in some embodiments, adding an acid to the metal chelate solution. Exemplary acids include hydrochloric, sulfuric, phosphoric, perchloric, nitric, and the like. In some embodiments, the acid is nitric acid. The large inverse micelle solution may be agitated prior to and/or after the addition of the acid.

The metal precursors useful in the methods disclosed can be any water soluble metal salt. For example, metal salts with hydrotropic counter anions and alkoxide sources of any metal may be used. The metal precursors also exhibit alcohol solubility. Illustrative metal precursors include, for example, metal nitrates, metal alkoxides, metal halides, metal phosphates, metal acetates, metal chlorides, metal iodides, metal sulfates, metal fluorides, metal thiocyanates, and the like. In some embodiments, the metal precursor includes a metal oxide, a metal nitrate, or a metal chloride.

The metal precursors useful in the process set forth herein include precursors of alkali metals, alkaline earth metals, transition metals, lanthanides, and actinides. In some embodiments, the metal precursor is a precursor of an s-block metal, a p-block metal, a d-block metal, or an f-block metal. In some embodiments, the metal precursor is a precursor of magnesium, calcium, vanadium, nickel, zinc, zirconium, hafnium, tin, lanthanum, or cerium. In some embodiments, the metal precursor is selected from the group: magnesium oxide, calcium nitrate, vanadium oxide, nickel nitrate, zinc nitrate, zirconium oxide, hafnium chloride, tin chloride, lanthanum oxide, and cerium nitrate.

The concentration of the metal precursors used in the methods disclosed herein is any concentration sufficient to form the metal chelate solution with the solvent and can vary based on the quantity of solution being produced, the metal precursor being used, as well as the solvent and surfactant system. As such, the methods disclosed herein are not limited by concentration of the metal precursor.

Any solvent capable of forming a chelate with the metal or metal precursor can be used in the disclosed methods. In some embodiments, the solvent is a diol. As used herein a “diol” refers to a compound which contains two hydroxyl groups, on a saturated or unsaturated hydrocarbon backbone. Essentially, a diol is a hydrocarbon in which two hydrogen atoms are replaced with hydroxyl groups. Diols have the general structure of (CH₂)nH₂O₂, where n represents the number of methyl groups or carbons. Examples of diols for use in the disclosed methods are those in which the compound includes a hydrocarbon backbone with 2-5 carbon atoms. Further, exemplary diols suitable for use include ethanediols, propanediols, butanediols, pentanediols, or a combination thereof. The diol(s) may have hydroxyl groups which are connected to different carbon atoms, for example, ethylene glycol, propane-1,2-diol, propane-1,3-diol, butane-1,2-diol, butane-1,3-diol, butane-1,4-diol, 2-methylpropane-1,2-diol, 2-methylpropane-1,3-diol, pentane-1,2-diol, pentane-1,3-diol, pentane-1,4-diol, 2-methyl-pentane-2,4-diol, pentane-2,3-diol, pentane-2,4-diol, and 2,3-dimethylbutane-2,3-diol. There may also be a mixture of different diols, such as 2, 3, 4 or 5 different diols, in combination. In some embodiments, the solvent includes one or more of: ethylene glycol, 1,3 propanediol, 1,4 butanediol, 1,5 pentane diol, and combinations thereof.

The concentration of the solvent in the methods disclosed herein is any concentration sufficient to form the metal chelate and the inverse micelles of the metal chelate and can vary based on the quantity of solution being produced, the metal precursor being used, as well as the surfactant.

Surfactants suitable for use may include anionic, cationic, non-ionic, zwitterionic surfactants, or mixtures thereof. The surfactant may be a block copolymer, or may be a random copolymer, an alternating copolymer, or some other type of copolymer. The block copolymer may be a diblock, triblock, or another copolymer. The block copolymer may have between 2 and 5 blocks or more than 5 blocks and the blocks may be the same or different type or copolymer. The block copolymer may have hydrophilic blocks alternating with hydrophobic blocks, for example an amphiphilic block copolymer. The terminal blocks may be hydrophobic, or may be hydrophilic, or one may be hydrophilic and one hydrophobic. The surfactant may be an alkylene oxide block copolymer surfactant. The surfactant may be an ethylene oxide (EO)/propylene oxide (PO) copolymer surfactant, e.g., an EO/PO block copolymer surfactant. In some embodiments, the EO/PO block copolymer surfactant is a triblock co-polymers of ethylene oxide/propylene oxide/ethylene oxide, also known as poloxamers, having the general formula HO(C₂H₄O)ₐ(—C₃H₆O)_{b}(C₂H₄O)ₐH, wherein a is a value from about 10 to about 150, preferably from about 20 to about 100, and more preferably form about 20 to about 70, and b is a value from about 5 to about 150, preferably from about 10 to about 70, and more preferably form about 10 to about 30, available under Pluronic® and poloxamer designations (e.g., Pluronic P65, P85, F108, P123, F127, and the like).

Nonionic surfactants include, for example, polyoxyl stearates such as polyoxyl 40 stearate, polyoxyl 50 stearate, polyoxyl 100 stearate, polyoxyl 12 distearate, polyoxyl 32 distearate, and polyoxyl 150 distearate, and other Myrj™ series of surfactants, or mixtures thereof.

Other useful surfactants include sugar ester surfactants, sorbitan fatty acid esters such as sorbitan monolaurate, sorbitan monopalmitate, sorbitan monostearate, sorbitan tristearate, and other Span™ series surfactants, glycerol fatty acid esters such as glycerol monostearate, polyoxyethylene derivatives such as polyoxyethylene ethers of high molecular weight aliphatic alcohols (e.g., Brij 30, 35, 58, 78 and 99) polyoxyethylene stearate (self-emulsifying), polyoxyethylene 40 sorbitol lanolin derivative, polyoxyethylene 75 sorbitol lanolin derivative, polyoxyethylene 6 sorbitol beeswax derivative, polyoxyethylene 20 sorbitol beeswax derivative, polyoxyethylene 20 sorbitol lanolin derivative, polyoxyethylene 50 sorbitol lanolin derivative, polyoxyethylene 23 lauryl ether, polyoxyethylene 2 cetyl ether with butylated hydroxyanisole, polyoxyethylene 10 cetyl ether, polyoxyethylene 20 cetyl ether, polyoxyethylene 2 stearyl ether, polyoxyethylene 10 stearyl ether, polyoxyethylene 20 stearyl ether, polyoxyethylene 21 stearyl ether, polyoxyethylene 20 oleyl ether, polyoxyethylene 40 stearate, polyoxyethylene 50 stearate, polyoxyethylene 100 stearate, polyoxyethylene derivatives of fatty acid esters of sorbitan such as polyoxyethylene 4 sorbitan monostearate, polyoxyethylene 20 sorbitan tristearate, and other Tween™ series of surfactants, phospholipids and phospholipid fatty acid derivatives such as lecithins, fatty amine oxides, fatty acid alkanolamides, propylene glycol monoesters and monoglycerides, such as hydrogenated palm oil monoglyceride, hydrogenated soybean oil monoglyceride, hydrogenated palm stearine monoglyceride, hydrogenated vegetable monoglyceride, hydrogenated cottonseed oil monoglyceride, refined palm oil monoglyceride, partially hydrogenated soybean oil monoglyceride, cotton seed oil monoglyceride sunflower oil monoglyceride, sunflower oil monoglyceride, canola oil monoglyceride, succinylated monoglycerides, acetylated monoglyceride, acetylated hydrogenated vegetable oil monoglyceride, acetylated hydrogenated coconut oil monoglyceride, acetylated hydrogenated soybean oil monoglyceride, glycerol monostearate, monoglycerides with hydrogenated soybean oil, monoglycerides with hydrogenated palm oil, succinylated monoglycerides and monoglycerides, monoglycerides and rapeseed oil, monoglycerides and cottonseed oils, monoglycerides with propylene glycol monoester sodium stearoyl lactylate silicon dioxide, diglycerides, triglycerides, polyoxyethylene steroidal esters, Triton-X series of surfactants produced from octylphenol polymerized with ethylene oxide, where the number “100” in the trade name is indirectly related to the number of ethylene oxide units in the structure, (e.g., Triton X-100™ has an average of N=9.5 ethylene oxide units per molecule, with an average molecular weight of 625) and having lower and higher mole adducts present in lesser amounts in commercial products, as well as compounds having a similar structure to Triton X-100™ including Igepal CA-630™ and Nonidet P-40M (NP-40™, N-lauroylsarcosine, Sigma Chemical Co., St. Louis, Mo.), and the like. Any hydrocarbon chains in the surfactant molecules can be saturated or unsaturated, hydrogenated or unhydrogenated.

Sugar ester surfactants include sugar fatty acid monoesters, sugar fatty acid diesters, triesters, tetraesters, or mixtures thereof, although mono- and di-esters are most preferred. Preferably, the sugar fatty acid monoester includes a fatty acid having from 6 to 24 carbon atoms, which may be linear or branched, or saturated or unsaturated C₆ to C₂₄ fatty acids. The C₆ to C₂₄ fatty acids may include stearates, behenates, cocoates, arachidonates, palmitates, myristates, laurates, carprates, oleates, laurates and their mixtures, and can include even or odd numbers of carbons in any subrange or combination. The sugar fatty acid monoester may include at least one saccharide unit, such as sucrose, maltose, glucose, fructose, mannose, galactose, arabinose, xylose, lactose, sorbitol, trehalose or methylglucose. Disaccharide esters such as sucrose esters may be used, and include sucrose cocoate, sucrose mono-octanoate, sucrose mono-decanoate, sucrose mono- or dilaurate, sucrose mono-myristate, sucrose mono- or dipalmitate, sucrose mono- and distearate, sucrose mono-, di- or trioleate, sucrose mono- or dilinoleate, sucrose polyesters, such as sucrose pentaoleate, hexaoleate, heptaoleate or octooleate, and mixed esters, such as sucrose palmitate/stearate.

One of the characteristics of surfactants is the HLB value, or hydrophilic lipophilic balance value. This value represents the relative hydrophilicity and relative hydrophobicity of a surfactant molecule. Generally, the higher the HLB value, the greater the hydrophilicity of the surfactant while the lower the HLB value, the greater the hydrophobicity. Surfactants suitable for use in the methods disclosed herein preferably have a HLB of less than 20.

The concentration of the surfactant(s) in the methods disclosed herein is any concentration sufficient to form the inverse micelles of the metal chelate and can vary based on the quantity of solution being produced, the metal precursor being used, as well as the solvent.

The surface area of the metal oxide nanomaterials, e.g., BET surface area, may be between about 10 and about 200 m²/g. In some embodiments the surface area is about 10, about 20, about 30, about 40, about 50, about 60, about 70, about 80, about 90, about 100, about 110, about 120, about 130, about 140, about 150, about 160, about 170, about 180, about 190 or about 200 m²/g. Thus, the surface area may be, for example, between about 50 and about 200 m²/g, about 100 and about 200 m²/g, about 150 and about 200 m²/g, about 10 and about 150 m²/g, about 10 and about 100 m²/g, about 10 and about 50 m²/g, about 50 and about 200 m²/g, about 50 and about 150 m²/g, about 50 and about 100 m²/g, about 100 and about 200 m²/g, about 100 and about 150 m²/g, or about 150 and about 200 m²/g.

The pore volume (BJH) of the metal oxide nanomaterials may be greater than about 0.1 cc/g or cm³/g. For example, the pore volume may be greater than about 0.2, 0.3, 0.4, 0.5, 0.6, 0.7, 0.8, 0.9, 1.0, 1.1, 1.2, 1.3, 1.4, or more cc/g. The pore volume may be between 0.1 and 2 cc/g.

The average diameter of the pores (pore size) of the metal oxide nanomaterials, e.g., BJH desorption, may be between about 2 and 50 nm, or between about 3 and about 20 nm or about 15 and about 30 nm. In some embodiments, the pore size may be greater than about 10 nm. For example, the pore size may be between about 10 and about 20 nm, about 10 and about 30 nm, about 10 and about 40 nm, about 10 and about 50 nm, about 20 and about 30 nm, about 20 and about 40 nm, about 20 and about 50 nm, about 30 and about 40 nm, about 30 and about 50 nm, or about 40 and about 50 nm. Thus, the metal oxide nanomaterials may be mesoporous. Mesoporous materials are porous materials containing pores with diameters between 2 and 50 nm. In some embodiments, the metal oxide nanomaterials may be large pore diameter mesoporous metal oxide nanomaterials, having a pore size greater than 10 nm. Alternatively, the metal oxide nanomaterials may be small pore diameter mesoporous metal oxide nanomaterials, having a pore size less than 10 nm

Additionally, the present disclosure provides metal oxide nanomaterials synthesized, fully or partially, by the methods disclosed herein.

Also provided herein are metal oxide nanomaterials including at least one, two or all of: pores with average diameters greater than about 2 nm, pores with total volumes greater than about 0.1 cc/g, and surface area greater than 10 m²/g. In some embodiments, the metal oxide nanomaterials include at least one of magnesium, calcium, vanadium, nickel, zinc, zirconium, hafnium, tin, lanthanum, and cerium. In some embodiments, the metal oxide nanomaterials are synthesized, fully or partially, by the methods disclosed herein.

In some embodiments, the average diameters of the pores may be greater than about 10 nm (e.g., about 20 nm, about 30 nm, about 40 nm, about 50 nm, or more). For example, the average diameters of the pores may be between about 10 and about 20 nm, about 10 and about 30 nm, about 10 and about 40 nm, about 10 and about 50 nm, about 20 and about 30 nm, about 20 and about 40 nm, about 20 and about 50 nm, about 30 and about 40 nm, about 30 and about 50 nm, or about 40 and about 50 nm.

In some embodiments, the total volume of the pores may be greater than about 1 cc/g. For example, the total volume of the pores may be greater than about 1.0, 1.1, 1.2, 1.3, 1.4, or more cc/g.

In some embodiments the surface area is greater than about 50, about 60, about 70, about 80, about 90, about 100, about 110, about 120, about 130, about 140, about 150, about 160, about 170, about 180, about 190, about 200 m²/g or more. Thus, the surface area may be, for example, between, about 50 and about 200 m²/g, about 50 and about 150 m²/g, about 50 and about 100 m²/g, about 100 and about 200 m²/g, about 100 and about 150 m²/g, or about 150 and about 200 m²/g.

### 2. Methods of Use

The present disclosure provides methods for using the metal oxide nanomaterials described herein. The metal oxide nanomaterials can be utilized in a variety of applications including, for example, catalysis, gas adsorption, adsorption of other molecules, synthesis of quantum dots and magnetic nanoparticles in functional materials and bioimaging applications, as carriers for drugs, genes and proteins for biomedical applications, chromatography or separation of compounds, and diagnosis. In particular, the metal oxide nanomaterials disclosed herein are useful for sorbent applications.

As such, the disclosure provides methods of using the metal oxide nanomaterials disclosed herein or devices including the metal oxide nanomaterials disclosed herein in any of methods including catalysis, adsorption, drug delivery, chromatography, and diagnosis.

Disclosed herein are methods of adsorbing, separating, storing, or sequestering carbon dioxide. In some embodiments, the methods include contacting the metal oxide nanomaterial disclosed herein or a system or device including the metal oxide nanomaterial with an input gas stream containing carbon dioxide to form a resulting gas stream with a lower amount of carbon dioxide than the input gas stream. In some embodiments, the methods further include desorbing at least a portion of the adsorbed carbon dioxide to form a desorbed carbon dioxide portion.

The methods are suitable for any gas including carbon dioxide in which the goal is to adsorb, separate, store, or sequester the carbon dioxide. For example, the methods may be used to enrich a gas for other components or remove damaging carbon dioxide. In some embodiments, the input gas is natural gas, ambient air, environmental control air, flue gas, or other impure gas mixtures containing carbon dioxide.

The methods may further include additional purification of the input gas. In some embodiments, the methods may further include removing particulate matter from the input gas. In some embodiments, the methods may further include removing other components from the gas, e.g., carbon monoxide, nitrogen oxides, ground-level ozone, and the like.

Disclosed herein are methods of adsorbing, separating, storing, or sequestering a molecule. In some embodiments, the methods include contacting the metal oxide nanomaterial disclosed herein or a system or device including the metal oxide nanomaterial with a sample including the molecule.

The molecule may be a macromolecule (e.g., a nucleic acid, a protein, a carbohydrate), a small molecule therapeutic or prophylactic, or contaminant. The contaminant may be any physical, chemical, biological substance which is targeted for removal from a sample for reasons of purity, separation, harm, or risk of the sample prior to removal.

As used herein, the term “sample” is used in its broadest sense. In one sense, it is meant to include a specimen obtained from any source, including biological samples and environmental samples. Environmental samples may be obtained from a river, ocean, lake, rain, snow, sewage, sewage processing runoff, agricultural runoff, industrial runoff, tap water or drinking water; or a foodstuff sample obtained from tap water, drinking water, prepared food, processed food, or raw food. An environmental sample may include liquid samples from a river, lake, pond, ocean, glaciers, icebergs, rain, snow, sewage, reservoirs, tap water, drinking water, etc.; solid samples from soil, compost, sand, rocks, concrete, wood, brick, sewage, etc.; and gaseous samples from the air, underwater heat vents, industrial exhaust, vehicular exhaust, etc. Biological samples may be obtained from animals (including humans) and encompass fluids, solids, tissues, and gases. Such examples are not however to be construed as limiting the sample types. Preferably, a sample is a fluid sample such as a liquid sample. Examples of liquid samples that may be assayed include bodily fluids (e.g., blood, serum, plasma, saliva, urine, ocular fluid, semen, sputum, sweat, tears, and spinal fluid). Viscous liquid, semisolid, or solid samples or specimens may be used to create liquid solutions, eluates, suspensions, or extracts that can be samples. Samples can include biological materials, such as cells, microbes, organelles, and biochemical complexes. Liquid samples can be made from solid, semisolid, or highly viscous materials, such as fecal matter, tissues, organs, biological fluids, or other samples that are not fluid in nature. For example, solid or semisolid samples can be mixed with an appropriate solution, such as a buffer, a diluent, and/or extraction buffer. The sample can be macerated, frozen and thawed, or otherwise extracted to form a fluid sample. Residual particulates may be removed or reduced using conventional methods, such as filtration or centrifugation. In some embodiments, the sample is a gas sample. In some embodiments, the sample is a liquid sample.

Also disclosed herein are methods for delivering a cargo molecule to a subject including administering to a cell, tissue, or subject in need thereof a composition or device including the metal oxide nanomaterial described herein and the cargo molecule.

In some embodiments, the cell is a prokaryotic cell. In some embodiments, the cell is a eukaryotic cell (e.g., a mammalian cell, a human cell). The cell may be in vitro, ex vivo, or in vivo.

A “subject” or “patient” may be human or non-human and may include, for example, animal strains or species used as “model systems” for research purposes, such a mouse model as described herein. Likewise, patient may include either adults or juveniles (e.g., children). Moreover, patient may mean any living organism, preferably a mammal (e.g., human or non-human) that may benefit from the administration of compositions contemplated herein. Examples of mammals include, but are not limited to, any member of the Mammalian class: humans, non-human primates such as chimpanzees, and other apes and monkey species; farm animals such as cattle, horses, sheep, goats, swine; domestic animals such as rabbits, dogs, and cats; laboratory animals including rodents, such as rats, mice and guinea pigs, and the like. Examples of non-mammals include, but are not limited to, birds, fish, and the like. In one embodiment of the methods and compositions provided herein, the mammal is a human.

In some embodiments, the cargo molecule is a therapeutic or prophylactic agent, an imaging agent, or a diagnostic agent. Examples of suitable therapeutic agents and/or prophylactic agents include antibiotics, chemotherapeutic agents, biologics such as proteins and antibody or antigen-binding compositions, nutraceuticals, vaccines, adjuvants, vitamins, minerals, growth factors, hormones, analgesics, or any other compound (e.g., a small molecular compound) that is intended to have an effect on a body, organ, tissue, cell, or cellular component. In some embodiments, the therapeutic agent is a nucleic acid, a protein, a carbohydrate, or a small molecule.

Imaging agents include any compound or composition which allow visualization of the function or state of a cell, tissue, organ, or subject while leaving other functions generally unaffected. Diagnostic agents include any compound or composition which facilitate or perform an analysis of a cell, tissue, organ, or subject. Exemplary diagnostic and imaging agents include dyes (e.g., fluorescent dyes), contrast media (e.g., absorbs or alters external electromagnetism or ultrasound), radiolabeled compounds (e.g., which emit radiation), labeled or unlabeled binding agents (e.g., antibodies), and the like.

The compositions can be administered by any suitable means. Examples of suitable means include parenteral, subcutaneous, intraperitoneal, intrapulmonary, intranasal, topical, and oral administration. Parenteral infusions include intramuscular, intravenous, intraarterial, intraperitoneal, or subcutaneous administration. The compositions can be formulated into any suitable formulation, including but not necessarily limited to pharmaceutical formulations, and thus can include any pharmaceutically acceptable stabilizers, excipients, carriers, and the like. The compositions can be provided as a solution, suspension, emulsion, dispersion, or as a powder, pill, tablet, or capsule.

The phrase “pharmaceutically acceptable,” as used in connection with compositions of the present disclosure, refers to molecular entities and other ingredients of such compositions that are physiologically tolerable and do not typically produce untoward reactions when administered to a subject (e.g., a mammal, a human). Preferably, as used herein, the term “pharmaceutically acceptable” means approved by a regulatory agency of the Federal or a state government or listed in the U.S. Pharmacopeia or other generally recognized pharmacopeia for use in mammals, and more particularly in humans. “Acceptable” means that the carrier is compatible with the active ingredient of the composition (e.g., the nucleic acids, vectors, cells, or therapeutic antibodies) and does not negatively affect the subject to which the composition(s) are administered. Any of the pharmaceutical compositions and/or cells to be used in the present methods can include pharmaceutically acceptable carriers, excipients, or stabilizers in the form of lyophilized formations or aqueous solutions.

### 3. Systems or Devices

The present disclosure provides systems and devices including the metal oxide nanomaterials disclosed herein. In some embodiments, the systems and devices include a sorption unit and the metal oxide nanomaterial disposed within the sorption unit. The disclosed systems and devices may be configured for use within the methods disclosed herein or for applications including: catalysis, gas adsorption, adsorption, removal of contaminants, synthesis of quantum dots and magnetic nanoparticles in functional materials and bioimaging applications, and as carriers or delivery vehicles for drugs, genes, and proteins for biomedical applications.

For example, the sorption unit may include a filter unit that includes the metal oxide nanomaterial disposed within the filter, as those used for automobile ventilation systems, environmental or air control systems (e.g., in a building or aircraft), CO₂ scrubbing systems (e.g., to treat exhaust gases from industrial plants, exhaled air from life support systems), carbon capture systems, water filtration units, and the like.

The sorption unit may be a drug delivery or other medical device. For example, the metal oxide nanomaterial can be disposed on the surface of an implantable medical device to function as a reservoir for the drug or other therapeutic agent, including but not limited to a nucleic acid, a protein, a small molecule, a dye or imaging agent, and the like. The body of the device can be made from any suitable biocompatible material such as NiTi, steel, tungsten, gold, carbon fiber, plastic etc. The type of device and the location of implantation will depend on the disease to be treated and the drug to be delivered. The device can be a purpose-built implantable drug delivery device for implantation subcutaneously or within the circulatory system. Subcutaneous drug delivery devices of the invention could take the form of beads, rods, discs, or any other conveniently shaped device coated with the mesoporous oxide the mesoporous oxide drug reservoir film of the invention and loaded with a drug. In a sub-cutaneous embodiment, once released from the reservoir material, the drug enters systemic circulation and is transported to the site of action (target site). Alternatively, a device of the invention can be implanted in close proximity to the target site. In other alternative embodiments, the metal oxide nanomaterials can be used as a filter or membrane enclosing a reservoir of the biomolecules and regulating their release.

In some embodiments, the metal oxide nanomaterials can be used be used for separation of macromolecules as well as small molecules. For example, the sorption unit may include a chromatography column or membrane for use in absorbing or adsorbing nucleic acids, proteins, carbohydrates, and/or small molecules (e.g., therapeutic molecules like sucrose, curcumin, and dopamine). The sorption unit may be used in remediation units for removal of potentially harmful or hazardous substances.

### 4. EXAMPLES

### Materials and Methods

### Synthesis

For the synthesis of highly porous metal oxides, 2 g of metal precursor and 20 g of solvent (14 g for 1-butanol and water) as mentioned in Table 1 were added into a 250 mL beaker (1 L round bottom flask for elevated temperature). To this solution, 2.0 g of Pluronic P123, and 2 g of concentrated nitric acid (70 wt. % HNO3 in H2O) were added and stirred vigorously. The resulting solution was then transferred to a programmable oven for the direct calcination at a temperature a little higher than their respective solvent boiling points in order for evaporation to occur at a slower rate (1°/min). The dried product was further calcined at a higher temperature at a rate of 5°/min and labeled as follows:

### (1) Cn—X—SS-M-Y-T, (2) *Cn—X—SS-M-Y-T, (3) B—X—SS-M-Y-T, (4) G-X—SS-M-Y-T, (5) *G-X—SS-M-Y-T, and (6) W—X—SS-M-Y-T,

where:
Cn: n stands for the number of carbon units in the diols, and C symbolize carbon;
X designates metal precursors initial (Oxides, O; Nitrates, N; and the Sulfates, S) SS
denotes mesoporous metal oxides Steven Suib synthesis procedure;
M means metal;
Y represent calcination temperature in ° C.;
T symbolizes calcination time in an hour;
B, G, and W symbolizes 1-butanol and glycerol, and water solvents, respectively; and
Cn and *G: * indicate elevated temperature synthesis.

Material Characterization

Powder X-ray diffraction (PXRD) measurements were carried out on a Rigaku Ultima IV diffractometer (Cu Kα radiation, λ=1.5406 Å) with an operating voltage of 40 kV and a current of 44 mA. Wide-angle PXRD spectra were collected with a continuous scan rate of 2.0° min—1 over a 2θ range of 5-75.

Absorbance spectra were obtained using a Shimadzu UV-2450 instrument scanned from 800 nm to 200 nm. UV probe 2.35 software were used to record and analyze the spectra.

Nitrogen and CO₂ sorption isotherms were performed using a Quantachrome Autosorb iQ2 instrument using N₂ and CO₂ gas as the adsorbate at 77 K and 273 K respectively by a multipoint method. The material was degassed for 5 h under helium before measurement. The outgassing profile used for degassing is: target temperature 60° C.; rate 3 deg/min; soak time 30 minute, target temperature 90° C.; rate 3 deg/min; soak time 30 minute, and target temperature 150° C.; rate 3 deg/min; soak time 240 minutes. The surface area was calculated using the Brunauer-Emmett-Teller (BET) method, and the Barrett—Joyner-Halenda (BJH) method was utilized to calculate the pore sizes and pore volume from the desorption data of the isotherm.

Scanning Electron Microscopy (SEM) was done on an FEI Nova Nano SEM 450 instrument with an ultra-stable Schottky emitter at an accelerating voltage of 2.0 kV having a beam current of 2.0 mA.

High-resolution transmission electron microscopy (HRTEM) experiments were performed on a Thermo Fisher Titan TEM microscope at an operating voltage of 200 kV. The samples were prepared by casting the suspension of material onto a carbon-coated copper grid.

Thermogravimetric analysis mass spectrometry (TGA-MS) data were collected using a NETZSCH TG 209F1 Libra attached with a QMS 403C instrument. About 10-15 mg of samples were loaded and heated at the rate of 15° C./minute from 27° C. to 900° C. To create the inert atmosphere argon gas was used for purging.

X-ray photoelectron spectroscopy (XPS) characterization of the synthesized materials was carried out on a PHI model Quantum 2000 spectrometer with a scanning ESCA multiprobe (φPhysical Electronics Industries Inc.), using Al Kα radiation (λ=1486.6 eV) as the radiation source. Fixed analyzer transmission mode was used to record the spectra with pass energies of 187.85 eV and 29.35 eV for recording survey and high-resolution spectra, respectively. The powder samples were pressed on a double-sided carbon tape mounted on an Al coupon pinned to a sample stage with a washer and screw and then placed in the analysis chamber. Binding energies (BE) were measured for Mg 2p, Mg 2 s, Ca 2p, V 2p, Ni 2p, Zn 2p, Zr 3d, Hf 4f, Sn 3d, La 3d, Ce 3d, and 0-1.

All spectra were normalized to adventitious carbon (Binding Energy=284.4 eV). The XPS spectra obtained were analyzed and fitted using Casa XPS software (version 2.3.16). Infrared spectroscopy was measured using Brucker Alpha FT-IR Platinum-ATR.A Bruker AVANCE III, 400 MHz spectrometer, fitted with a Z-axis gradient and with automatic tuning and matching was used to record 1H Nuclear Magnetic Resonance (NMR) spectra. Samples were dissolved in D₂O solvent prior to collecting NMR spectra.

### Example 1

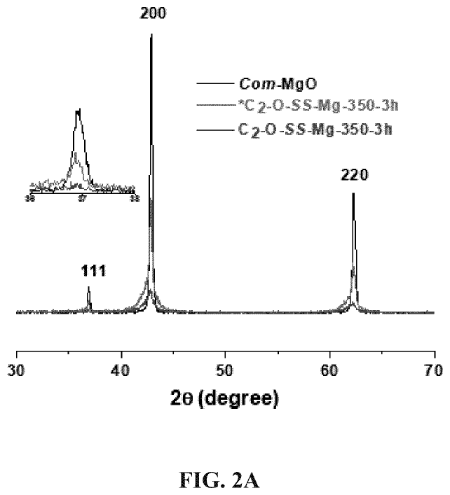

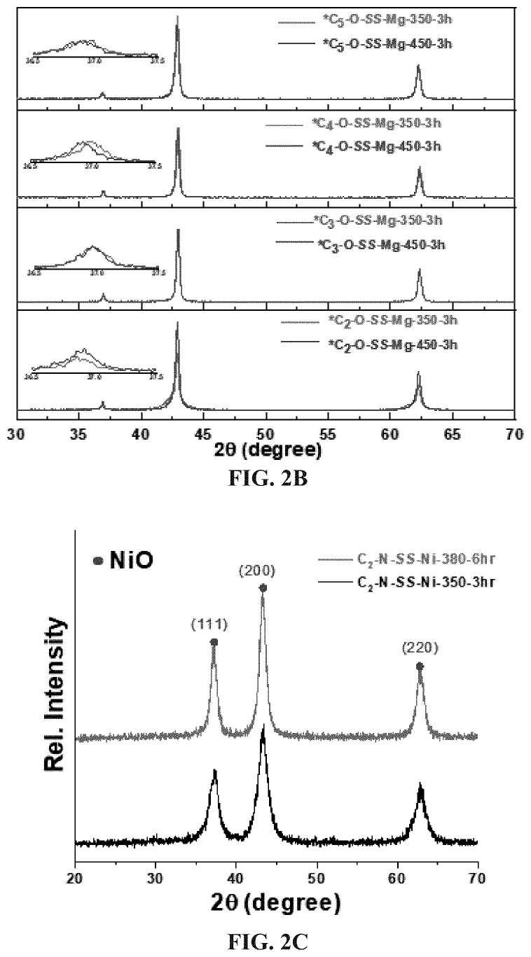

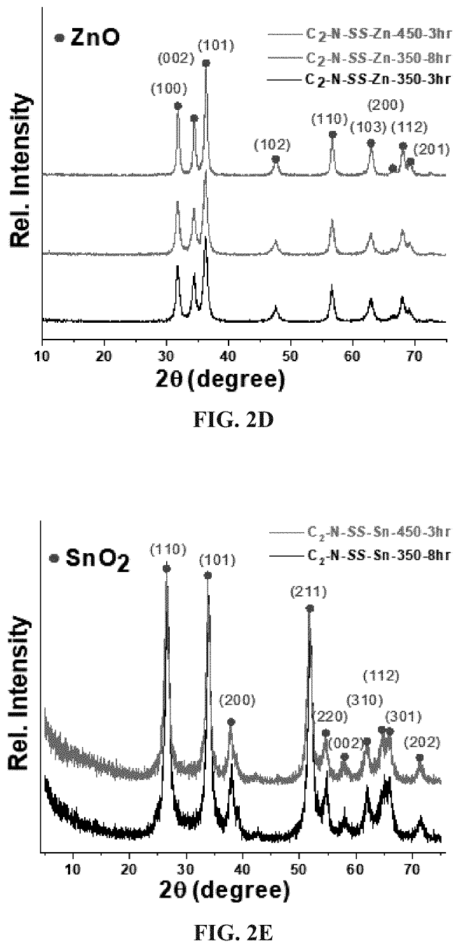

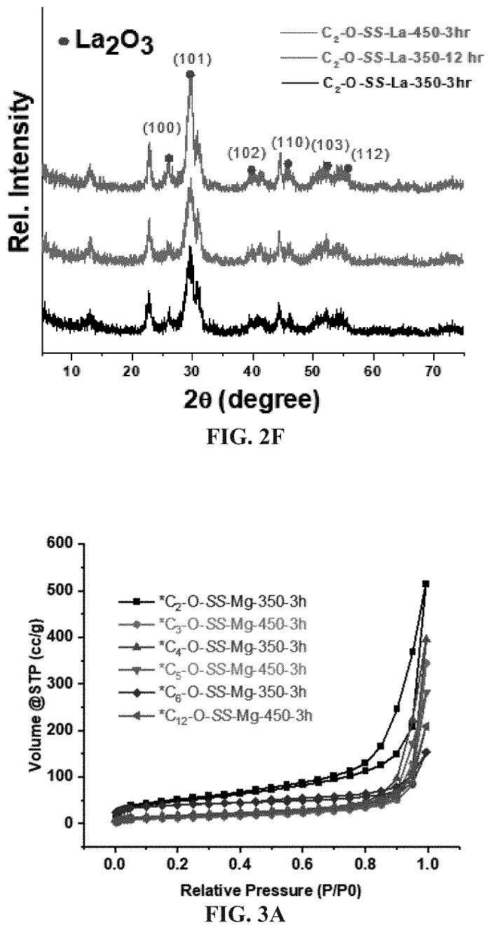

Powder X-ray diffraction was performed on all the synthesized catalysts to check the crystallinity. In the case of magnesium (FIGS. 2A and 2B), when the precursor was magnesium oxide, and the solvent was diol or glycerol, then crystallinity determined the result was pure magnesium oxide (PDF Card No.: 01-089-7746) with a cubic crystal system and Fm-3m(225) space group. Other solvents led to less crystalline magnesium oxide along with a phase impurity. A trend was seen with the synthesis temperature and the crystallinity among a specific solvent; higher temperature synthesis led to more crystalline catalyst formation as compared to room temperature, as demonstrated in that C₂—O—SS—Mg-350-3 h is a little less crystalline than *C₂—O—SS—Mg-350-3 h (FIG. 2A). Interestingly an increase or decrease in calcination temperature by ±50° C. did not affect the catalyst crystallinity, and very little difference was observed in the peak area (FIG. 2B). Powder X-ray diffraction of other metal oxides also showed crystalline behavior as shown in FIGS. 2C-2F: C₂—N—SS—Ca; CaCO₃ formula; calcite phase; PDF card no.: 01-083-4605; trigonal crystal system, C₂—O—SS—V; V₂O₅ formula; divanadium pentaoxide phase; PDF card no.: 01-089-0612; Orthorhombic crystal system, C₂—N—SS—Ni; NiO formula; bunsenite phase, PDF card no.: 00-047-1049; cubic crystal system, C₂—N—SS—Zn; ZnO formula; zinc oxide phase, PDF card no.: 01-080-0074; hexagonal crystal system, C₂—O—SS—Zr; ZrO₂ formula; baddeleyite phase, PDF card no.: 01-075-9454; monoclinic crystal system, C₂-C₁—SS—Hf; HfO₂ formula; hafnium oxide phase, PDF card no.: 01-078-5755; Orthorhombic crystal system, C₂—N—SS—Sn; SnO₂ formula; cassiterite phase, PDF card no.: 01-071-0652; tetragonal crystal system, C₂—O—SS—La; La₂O₃ formula; lanthanum oxide phase, PDF card no.: 00-005-0602; hexagonal crystal system, and C₂—N—SS—Ce shows CeO₂ formula; ceria phase, PDF card no.: 00-067-0123; cubic crystal system.

A nitrogen sorption study was done to check the surface areas, pore diameters, and pore volumes of all the catalysts. In the case of magnesium, different conditions were used to synthesize magnesium oxide, and BET-BJH analysis was performed (Table 1, entry 1 to 18). Magnesium nitrate, magnesium oxide, and magnesium sulfate were used as a precursor, and magnesium oxide shows the best of BET-BJH results based on large surface area and pore volume. Similarly, 1-butanol, water, diol, and glycerol were tried as solvents, and in this case, diol was found to be preferred. Although glycerol and 1-butanol conferred comparable surface areas, they yielded smaller pore size distributions and less pore volume.

With diols having the preferred results, the synthesis procedure was expanded to include higher diols (Table 1, entry 1 to 13). Ethane diol, propane diol, butane diol, pentane diol, hexanediol, and the dodecane diol were tried and interestingly except for hexanediol and dodecane diol, all other systems resulted in higher pore diameters. Room temperature syntheses were found to result in a preferred product than higher temperature syntheses (Table 1, entry 14,15,16), with larger surface area, pore volumes and pore diameters.

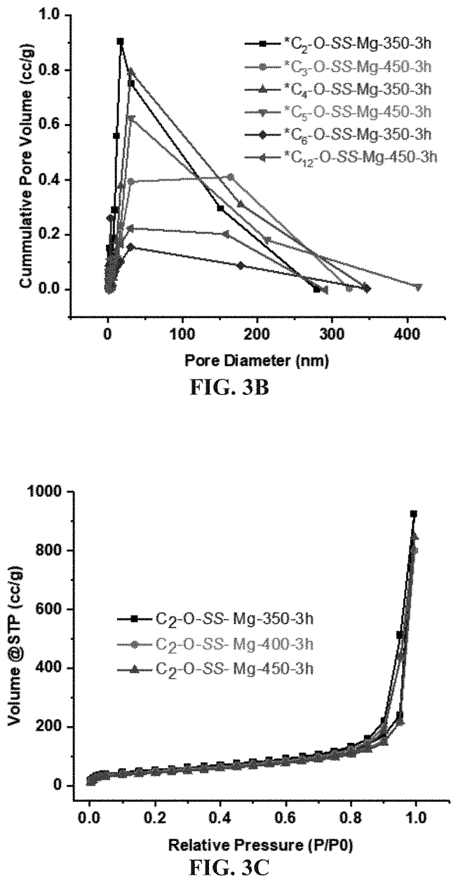

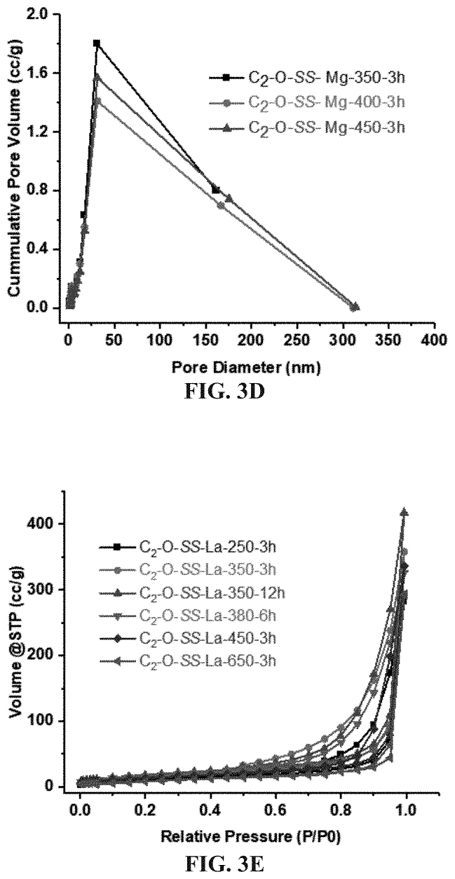

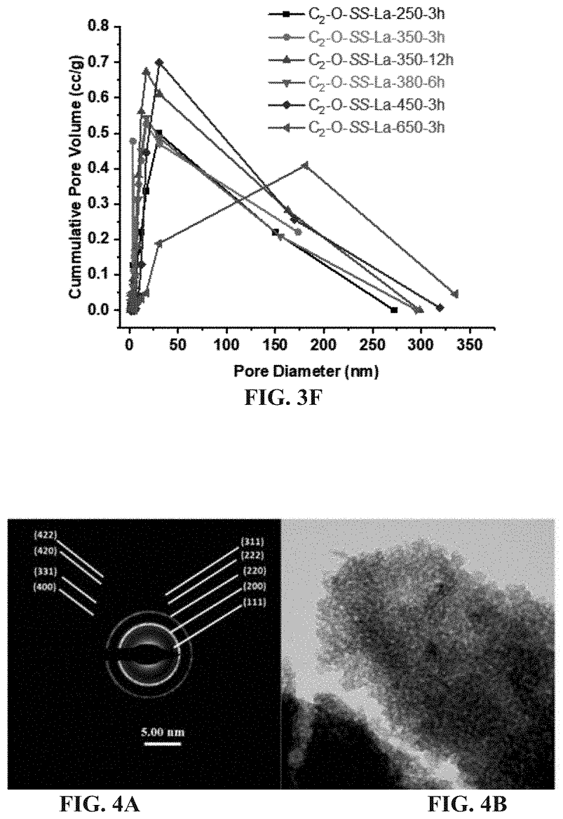

The effect of nitric acid in the synthesis procedure was also investigated. Significantly lower surface areas were recorded without nitric acid (Table 1, entry 17). Commercial magnesium oxides gave only 9 m²/g surface area (Table 1, entry 18), which suggested that in order to get a higher surface area and pore diameter, nitric acid treatment is mandatory. FIGS. 3A-3D show isotherms and pore size distributions of all the synthesized magnesium catalysts.

Glycol based, aside from hexane diol and dodecane diol, meso-MgO gave type IV mesoporous isotherms along with higher pore size monomodal distributions. Therefore, magnesium oxide precursors, ethylene glycol solvents, nitric acid inducers, and room temperature are preferred for the synthesis. Ethylene glycol was found to give as high as 31 nm pore diameters, 1.4 cc/g pore volumes, and 195 m²/g surface areas (Table 1, entry 14). This procedure was expanded to other mesoporous metal oxide syntheses.

Oxides of calcium, vanadium, nickel, zinc, zirconium, hafnium, tin, lanthanum, and cerium were successfully synthesized with higher pore diameters and monomodal pore size distributions (Table 1, entry 19 to 31). All the optimized catalysts C₂—N—SS—Ca-450-3 h; 30.889 nm; 18 m²/g; 0.170 cc/g, C₂—O—SS—V-350-3 h; 17.481 nm; 33 m²/g; 0.240 cc/g, C₂—N—SS—Ni-450-3 h; 12.306 nm; 20 m²/g; 0.091 cc/g, C₂—N—SS—Zn-450-3 h; 17.460 nm; 26 m²/g; 0.222 cc/g, C₂—O—SS—Zr-350-8 h; 17.296 nm; 24 m²/g; 0.218 cc/g, C₂-C₁—SS—Hf-350-3 h; 12.368 nm; 92 m²/g; 0.250 cc/g, C₂-C₁—SS—Sn-450-3 h; 17.596 nm; 48 m²/g; 0.263 cc/g, C₂—O—SS—La-450-3 h; 17.453 nm; 50 m²/g; 0.530 cc/g, and C₂—N—SS—Ce-350-3 h; 3.823 nm; 165 m²/g; 0.220 cc/g gave high pore diameters, surface areas, and pore volumes respectively. Each showed type IV mesoporous isotherms with monomodal pore size distributions (FIGS. 3E-3F).

Scanning electron microscopy was performed to check the morphologies of the synthesized catalysts. Although all the magnesium catalysts showed spherical morphologies, only C₂—O—SS—Mg-350-3 h and C₂—O—SS—Mg-450-3 h were non agglomerated. C₂—N—SS—Ca-450-3 h, C₂—N—SS—Ni-450-3 h, C₂—N—SS—Zn-350-3 h, C₂—N—SS—Zn-450-3 h, C₂—O—SS—Zr-350-8 h, C₂-C₁—SS—Hf-350-3 h, and C₂-C₁—SS—Sn-450-3 h showed spherical morphology. C₂—O—SS—V-350-3 h showed puzzle shape morphology at 350° C., whereas at a higher temperature, this material disintegrated and formed angular fractured grain shape morphology. C₂—N—SS—Ni-350-3 h showed fiber morphology, C₂—O—SS—La-450-3 h showed foam morphology, and C₂—N—SS—Ce-350-3 h showed stacked fiber morphology.

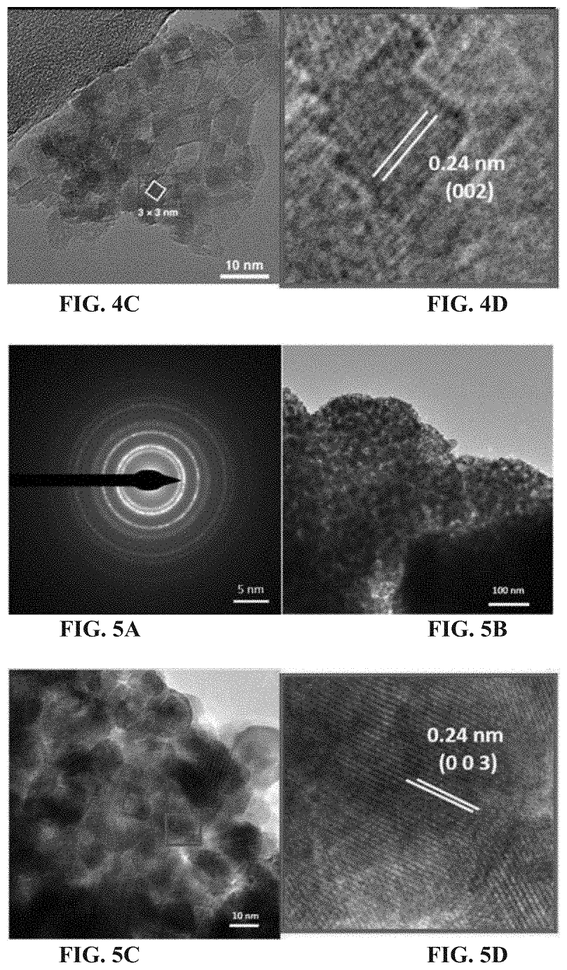

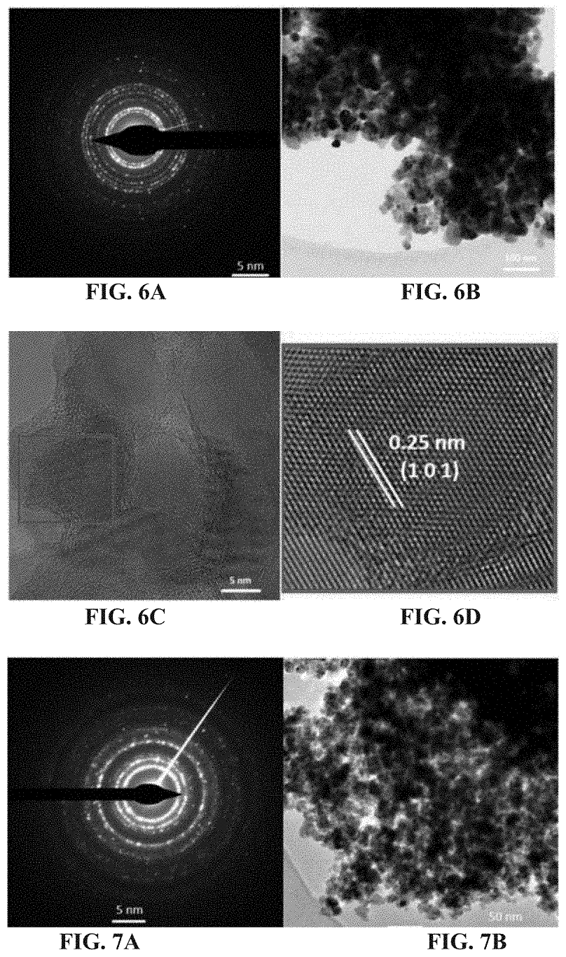

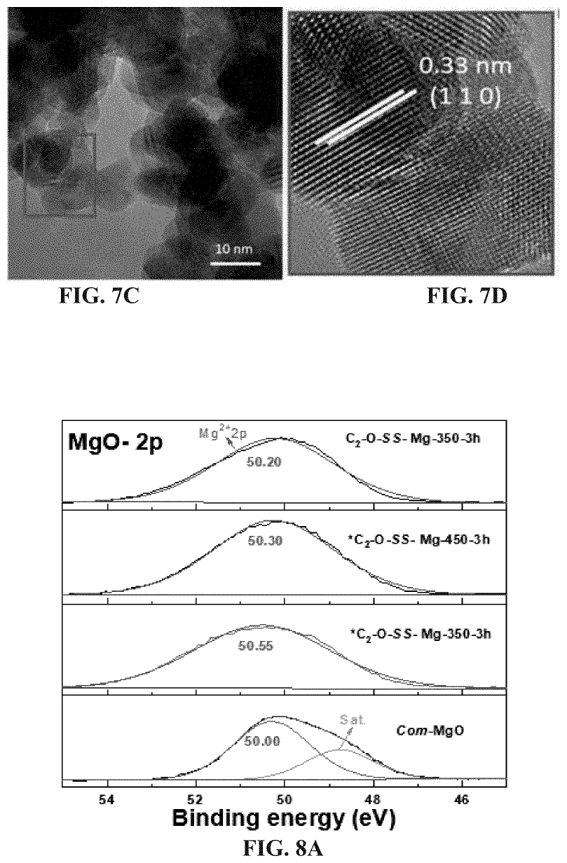

Furthermore, TEM imaging (FIGS. 4-7) was performed on all of the synthesized materials to check the nanomaterial behavior, metal oxides lattice fringes, and the d-spacings. For every catalyst and figure, four images are shown. A shows the selected area diffraction (SAED) pattern to examine the crystal structure and crystal defects. B exhibits nanomaterial behavior and homogeneity of the catalyst. C manifests the crystalline lattice fringes used to measure the d-spacings of the diffraction planes, and lastly, D shows zoomed images for better viewing of d-spacings and lattice fringes. For the magnesium, C₂—O—SS—Mg-350-3 h was found to give a preferred result with a 3*3 nm square nanoparticle and 0.24 nm of d-spacing which matches to (002) magnesium oxide plane (FIGS. 4A-4D). A slight decrease in nanomaterial behavior was observed with an increase in calcination temperature (C₂—O—SS—Mg-450-3 h) with a d-spacing of 0.21 nm and (200) predominate plane. Although *C₂—O—SS—Mg-350-3 h and *C₂—O—SS—Mg-450-3 h were more crystalline under XRD (FIG. 2A), they did not appear to be nanomaterials following imaging and particles were found to be significantly less ordered with agglomeration. The lattice fringes of *C₂—O—SS—Mg-350-3 h matched with the MgO and Mg(OH)₂ structures with a d spacing of 0.21 nm, (111) planes, and a d spacing of 0.25 nm, and (101) planes, respectively. C₂—N—SS—Ca-450-3 h showed crystalline behavior with semi-homogeneous particle size distribution. Interestingly, unlike XRD (shows bulk CaCO₃), the lattice fringes matched the (100) and (101) lattice planes of calcium oxide with the d spacings of 0.33 nm and 0.27 nm, respectively. Similarly, all other materials (FIGS. 5-7): C₂—O—SS—V-350-3 h; 0.34 nm; (100), C₂—N—SS—Ni-450-3 h; 0.24 nm; (003), C₂—N—SS—Zn-450-3 h; 0.25 nm; (101), C₂—O—SS—Zr-350-8 h; 0.36 nm; (011), C₂-C₁—SS—Hf-350-3 h; 0.29 nm; (211); 0.35 nm; (210), C₂-C₁—SS—Sn-450-3 h; 0.33 nm; (110), C₂—O—SS—La-450-3 h; 0.61 nm; (001); 0.34 nm; (100), and C₂—N—SS—Ce-350-3 h; 0.31 nm; (111) gave d spacings and corresponding matching planes respectively along with nanoparticle behavior and crystalline nature.

To study the stability of the synthesized materials, thermogravimetric analysis was performed. Except for C₂—N—SS—Ca-450-3 h all other catalysts were found to be quite stable. C₂—O—SS—Mg-350-3 h, C₂—N—SS—Ni-450-3 h, C₂-C₁—SS—Hf-350-3 h, and C₂—N—SS—Ce-350-3 h exhibited slight moisture loss due to water of crystallization in the lower temperature (<300° C.) region, resulting in mass losses of ˜5% to 15%. whereas C₂—O—SS—V-350-3 h, C₂—N—SS—Zn-450-3 h, C₂—O—SS—Zr-350-8 h, and C₂-C₁—SS—Sn-450-3 h had mass losses of only of −2-3% due to thermal drying. In the case of C₂—O—SS—Mg-350-3 h and C₂—O—SS—La-450-3 h surfactant loss was also seen around 300° C. to 400° C. C₂—O—SS—La-450-3 h at ˜650° C. lost additional weight of −10% due to the phase change. C₂—N—SS—Ca-450-3 h was found to be unstable in the higher temperature region and resulted in a loss of 50% of its weight. Constant tiny mass loss (˜2-3%) was observed in all of these materials at higher temperature due to thermal drying.

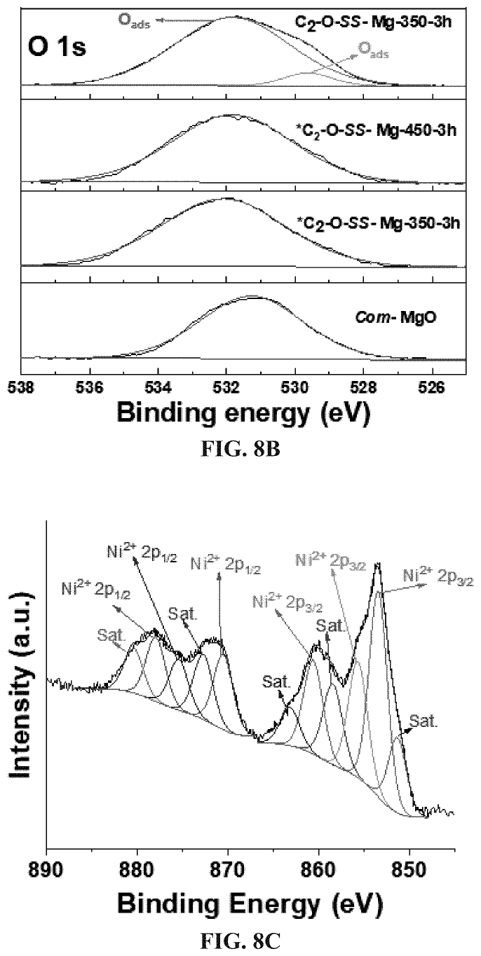

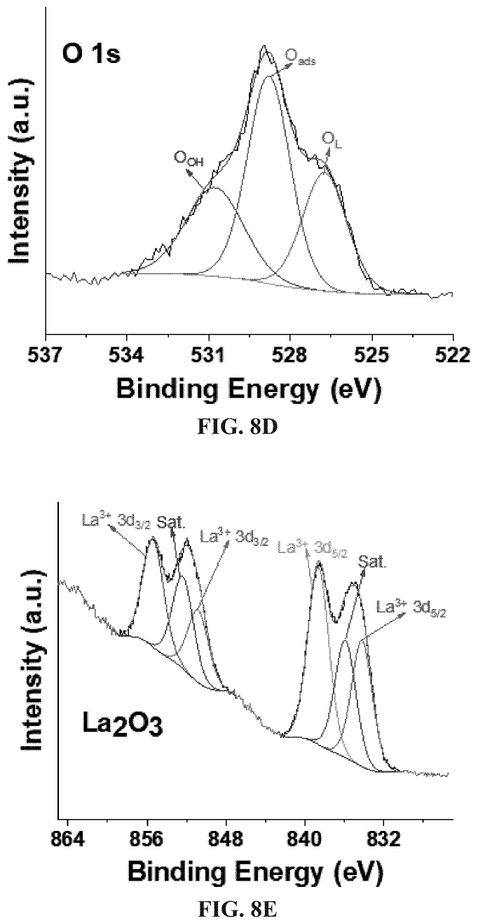

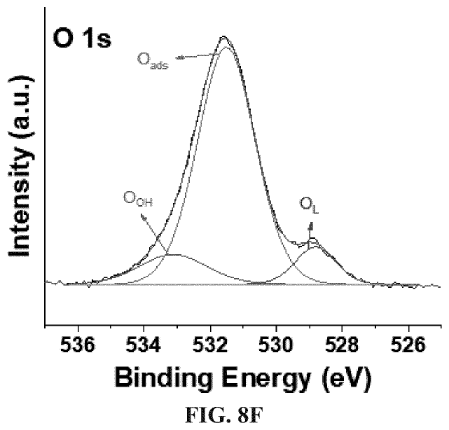

X-ray photoelectron spectroscopy was performed to determine the surface oxidation states of C₂—O—SS—Mg-350-3 h, *C₂—O—SS—Mg-450-3 h, *C₂—O—SS—Mg-350-3 h, and commercial magnesium oxide (FIGS. 8A and 8B). A shift in Mg-2p was observed (FIG. 8A) with an increase in synthesis temperature (binding energy increases) and calcination temperature (binding energy decreases), resulting in a peak at 50 eV. Higher temperature synthesized catalyst *C₂—O—SS—Mg-350-3 h had a peak at 50.55 eV. C₂—O—SS—Mg-350-3 h and *C₂—O—SS—Mg-450-3 h were found to have intermediate binding energies with values of 50.20 eV and 50.30 eV, respectively. Similarly, Mg is followed the same trend, and commercial magnesium oxide gave a peak at the lowest binding energy (1304.24 eV), whereas *C₂—O—SS—Mg-350-3 h gave a peak at the highest binding energy (1304.93 eV). O 1 s of magnesium oxide (FIG. 8B), only in the case of C₂—O—SS—Mg-350-3 h deconvolution, led to two types of oxygen, whereas in the other materials only one peak is observed. Lower binding energies were due to lattice oxygen, while at higher binding energy, these peaks were due to adsorbed oxygen.

Deconvoluted XPS spectra of calcium oxide showed two peaks, one for Ca⁺² 2p_{3/2} at ˜342 eV and another for Ca⁺² 2p_{1/2} at ˜346 eV. Oxygen deconvoluted spectra showed surface hydroxyl oxygen and adsorbed oxygen. Vanadium oxidation states in vanadium oxide were observed to be in the +5 oxidation state exhibiting two peaks along with many satellite peaks. The lower energy peak corresponded to the 2p_{3/2} transition and at higher energy, corresponding to 2p_{1/2}. O 1 s deconvoluted peaks of vanadium oxide showed three peaks, at lower energy for lattice oxygen, intermediate energies for adsorbed oxygen, and at higher energies for hydroxyl oxygen. Nickel oxide in XPS gave multiple peaks (FIG. 8C). Three peaks corresponded to Ni⁺²2p_{3/2}, and three other peaks corresponded to Ni⁺²2p_{1/2} along with their satellite peaks. O 1 s of NiO exhibited three types of oxygen, one for lattice oxygen, one for adsorbed oxygen, and the other one for hydroxyl oxygen (FIG. 8D). Two peaks were observed in the XPS spectra of zinc oxide for the zinc, one for Zn2p_{1/2} and another one for Zn2p_{3/2}, along with their satellite peaks. The O 1 s region of ZnO gave three peaks, a lower energy region for lattice oxygen, an intermediate energy region for adsorbed oxygen, and a higher energy region for hydroxyl oxygen. Deconvoluted spectra of zirconium gave three peaks, two peaks corresponding to Zr⁺⁴3d_{5/2}, and one peak at the higher energy region corresponding to satellite peaks. O 1 s spectra revealed two peaks, one for adsorbed oxygen and another one for hydroxyl oxygen. In the XPS of hafnium oxide, hafnium exhibited two peaks, and the O 1 s transition of hafnium revealed three peaks. Hf⁺⁴4f_{5/2} and Hf⁺⁴4f_{7/2} peaks were observed for metal and lattice oxygen, adsorbed oxygen, and the hydroxyl oxygen for the O 1 s deconvoluted spectra. Deconvoluted spectra of Sn showed two peaks corresponding to Sn⁺⁴3d_{5/2}. O 1 s spectra of SnO₂ give two peaks. The lower energy region corresponded to lattice oxygen, and higher energy corresponded to adsorbed oxygen. FIGS. 8E and 8F exhibit the deconvoluted XPS spectra of La₂O₃. La deconvoluted spectra show four peaks along with satellite peaks. The lower energy region gave two peaks for La⁺³3d_{5/2}, and the higher energy region gave another two peaks for La⁺³3d_{3/2} (FIG. 8E). The O 1 s deconvoluted spectra were due mainly to adsorbed oxygen along with a little bit of lattice and hydroxyl oxygen species (FIG. 8F). Cerium deconvoluted spectra gave 6 peaks; three peaks at the lower energy region corresponded to Ce⁺⁴3d_{5/2}, and another three peaks at the higher energy region corresponded to Ce⁺⁴3d_{3/2}. Unlike other metal oxides, O 1 s of cerium oxide gave four types of oxygen. These four from lower binding energy to higher energy are lattice oxygen, valence oxygen, adsorbed oxygen, and hydroxyl oxygen. However, the four peaks are dominated by valence and adsorbed oxygen.

TABLE 1
BET-BJH descriptors for all the synthesized catalysts with synthesis parameters

| | | | Rxn | | Surface | Pore | Pore |
|---|---|---|---|---|---|---|---|
| | | | Temp | Metal | area | volume | diameter |
| No. | Sample name | Solvent | (° C.)^{c} | precursor | (m²/g) | (cc/g) | (nm) |
| 1 | *C₂-O-SS-Mg-250-3 h | Ethylene glycol | 70 | MgO | 14 | 0.137 | 3.823 |
| 2 | *C₂-O-SS-Mg-350-3 h | Ethylene glycol | 70 | MgO | 174 | 0.792 | 17.569 |
| 3 | *C₂-O-SS-Mg-450-3 h | Ethylene glycol | 70 | MgO | 77 | 0.622 | 17.553 |
| 4 | *C₃-O-SS-Mg-350-3 h | 1,3-Propanediol | 70 | MgO | 64 | 0.543 | 3.825 |
| 5 | *C₃-O-SS-Mg-450-3 h | 1,3-Propanediol | 70 | MgO | 44 | 0.537 | 31.020 |
| 6 | *C₄-O-SS-Mg-350-3 h | 1,4-Butanediol | 70 | MgO | 66 | 0.617 | 31.010 |
| 7 | *C₄-O-SS-Mg-450-3 h | 1,4-Butanediol | 70 | MgO | 35 | 0.523 | 31.419 |
| 8 | *C₅-O-SS-Mg-350-3 h | 1,5-Pentanediol | 70 | MgO | 67 | 0.469 | 3.823 |
| 9 | *C₅-O-SS-Mg-450-3 h | 1,5-Pentanediol | 70 | MgO | 48 | 0.443 | 31.008 |
| 10 | *C₆-O-SS-Mg-350-3 h | 1,6-Hexanediol | 70 | MgO | 145 | 0.211 | 3.825 |
| 11 | *C₆-O-SS- Mg-450-3 h | 1,6-Hexanediol | 70 | MgO | 75 | 0.369 | 3.412 |
| 12 | *C₁₂-O-SS-Mg-350-3 h | 1,12-Dodecanediol | 90 | MgO | 76 | 0.294 | 1.689 |
| 13 | *C₁₂-O-SS-Mg-450-3 h | 1,12-Dodecanediol | 90 | MgO | 54 | 0.327 | 3.413 |
| 14 | C₂-O-SS- Mg-350-3 h | Ethylene glycol | RT | MgO | 195 | 1.440 | 31.182 |
| 15 | C₂-O-SS- Mg-400-3 h | Ethylene glycol | RT | MgO | 179 | 1.245 | 31.391 |
| 16 | C₂-O-SS- Mg-450-3 h | Ethylene glycol | RT | MgO | 158 | 1.315 | 31.366 |
| 17^{a} | *C₂-O-SS-Mg-350-3 h | Ethylene glycol | 70 | MgO | 10 | 0.205 | 1.935 |
| 18^{b} | Com-MgO | NA | NA | NA | 9 | 0.168 | 2.736 |
| 19 | C₂-N-SS-Ca-450-3 h | Ethylene glycol | RT | Ca(NO₃)₂ | 18 | 0.170 | 30.889 |
| 20 | C₂-O-SS-V-350-3 h | Ethylene glycol | RT | V₂O₅ | 33 | 0.240 | 17.481 |
| 21 | C₂-N-SS-Ni-350-3 h | Ethylene glycol | RT | Ni(II)(NO₃)₂ | 105 | 0.155 | 2.191 |
| 22 | C₂-N-SS-Ni-450-3 h | Ethylene glycol | RT | Ni(II)(NO₃)₂ | 20 | 0.091 | 12.306 |
| 23 | C₂-N-SS-Zn-350-3 h | Ethylene glycol | RT | Zn(II)(NO₃)₃ | 64 | 0.223 | 3.829 |
| 24 | C₂-N-SS-Zn-450-3 h | Ethylene glycol | RT | Zn(II)(NO₃)₃ | 26 | 0.222 | 17.460 |
| 25 | C₂-O-SS-Zr-350-8 h | Ethylene glycol | RT | ZrO₂ | 24 | 0.218 | 17.296 |
| 26 | C₂-Cl-SS-Hf-350-3 h | Ethylene glycol | RT | HfCl₄ | 92 | 0.250 | 12.368 |
| 27 | C₂-Cl-SS-Sn-300-12 h | Ethylene glycol | RT | SnCl₂ | 100 | 0.281 | 1.426 |
| 28 | C₂-Cl-SS-Sn-450-3 h | Ethylene glycol | RT | SnCl₂ | 48 | 0.263 | 17.596 |
| 29 | C₂-O-SS-La-350-12 h | Ethylene glycol | RT | La₂O₃ | 69 | 0.672 | 12.261 |
| 30 | C₂-O-SS-La-450-3 h | Ethylene glycol | RT | La₂O₃ | 50 | 0.530 | 17.453 |
| 31 | C₂-N-SS-Ce-350-3 h | Ethylene glycol | RT | Ce(III)(NO₃)₃ | 165 | 0.220 | 3.823 |

^{a}The reaction was done without HNO₃
^{b}NA stands for not applicable
^{c}RT stands for room temperature

### Example 2

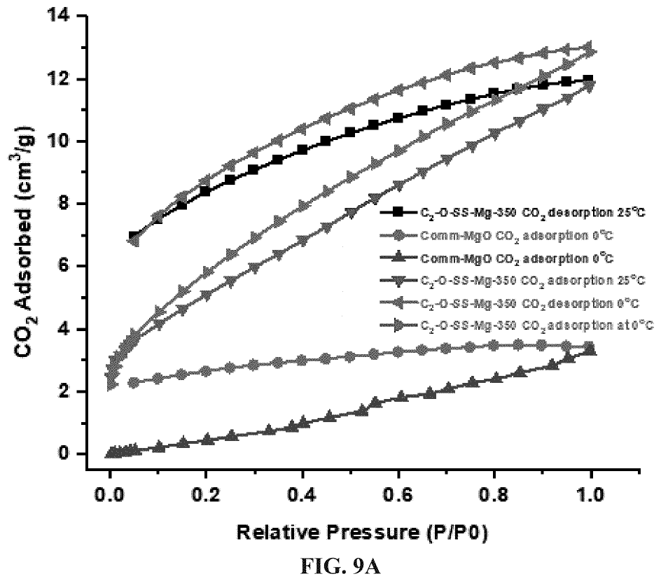

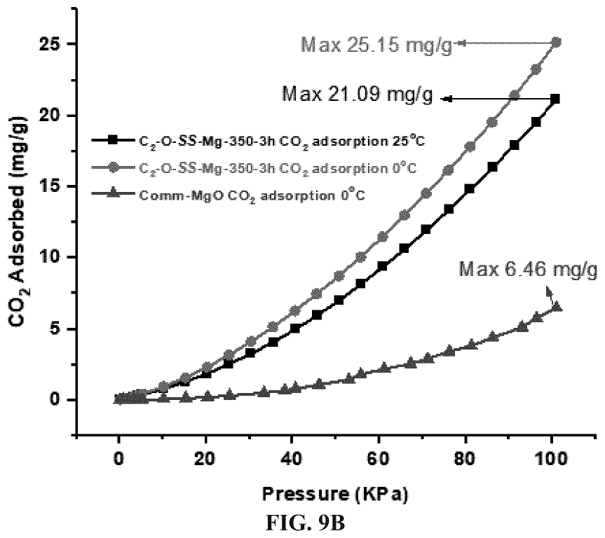

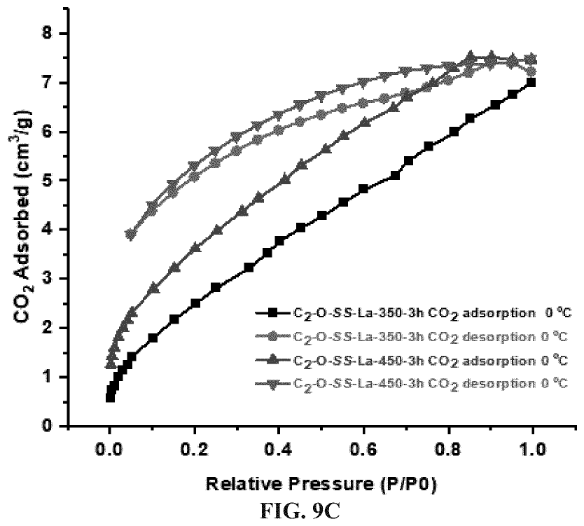

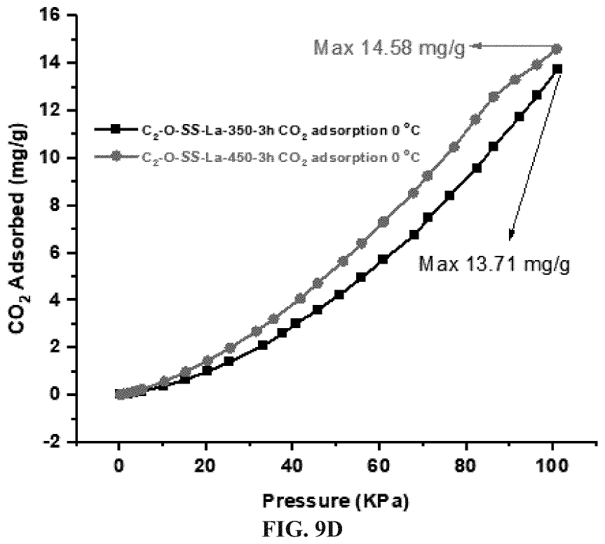

The higher pore diameter catalysts, primarily a mesoporous magnesium oxide, were studied for CO₂ adsorption-desorption and macromolecule sorption. FIG. 9 showcases the adsorption-desorption of magnesium oxide and lanthanum oxide. In the case of magnesium oxide, commercial magnesium oxide and C₂—O—SS—Mg-350-3 h were studied (FIGS. 9A and 9B). To study the effect of temperature on adsorption, C₂—O—SS—Mg-350-3 h were analyzed at 25° C. and 0° C. CO₂ adsorption at 0° C. was found to be maximized as compared to 25° C. Considering ideal gas behavior, CO₂ quantitative adsorption calculations were done and are plotted against the pressure (KPa). C₂—O—SS—Mg-350-3 h at 0° C. and 25° C. give 25.15 mg/g and 21.09 mg/g C₀₂ adsorption, whereas commercial magnesium oxide only gives 6.46 mg/g, which is four times lower than the maximum adsorption. Similarly, a CO₂ adsorption study was performed on C₂—O—SS—La-350-3 h and C₂—O—SS—La-450-3 h at 0° C. as lower temperature adsorption worked best (FIGS. 9C and 9D). C₂—O—SS—La-450-3 h gives 14.58 mg/g, and C₂—O—SS—La-350-3 h gives 13.71 mg/g CO₂ adsorption.

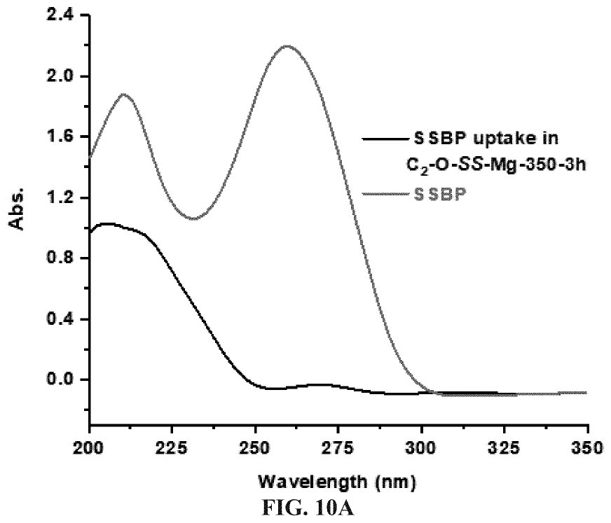

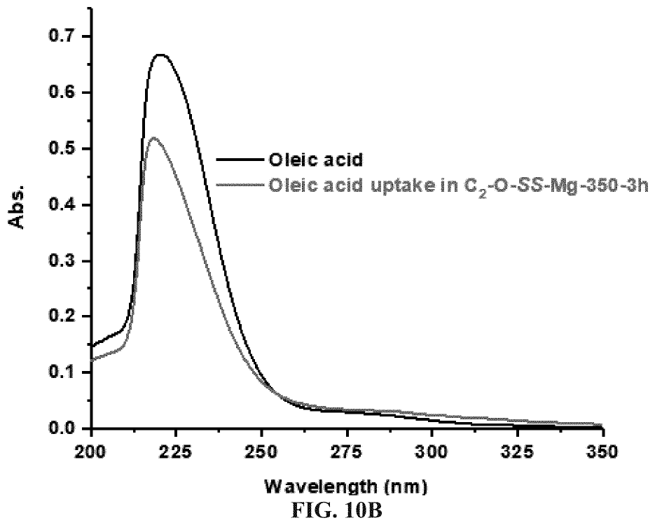

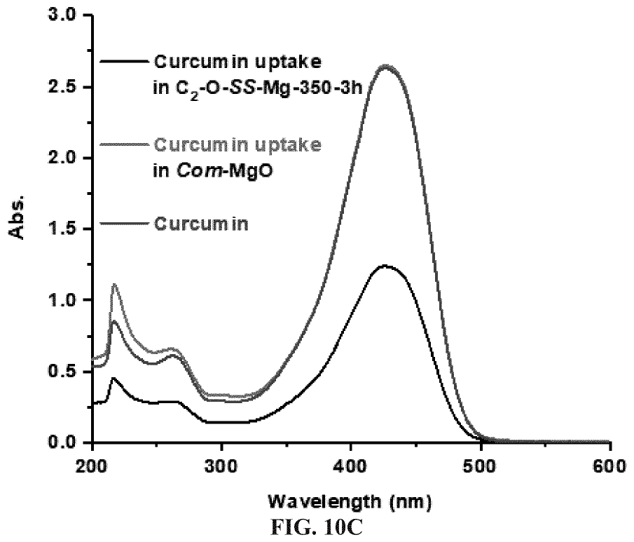

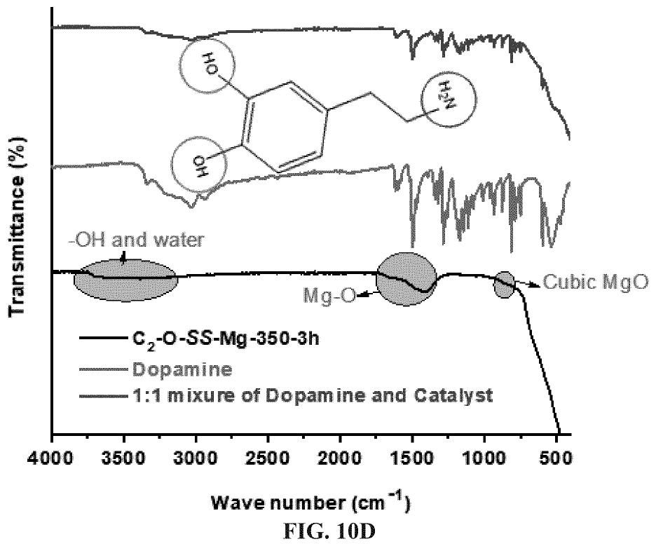

Macromolecular and small molecule sorption studies were performed on single-strand DNA-binding protein (SSBP), oleic acid (lipid family), curcumin, dopamine, sucrose, and sodium carboxymethylcellulose (polysaccharides). FIG. 10A shows the SSBP sorption with and without adsorbent. In the presence of C₂—O—SS—Mg-350-3 h adsorbent, SSBP peaks at 270 nm seem to almost disappear, which confirms the sorption. FIG. 10B shows the sorption of oleic acid and the sorption capacity is calculated to be 0.45 mg per mg of the catalyst. Curcumin also shows sorption in the presence of the adsorbent (FIG. 10C). No difference in observance was observed in curcumin and curcumin with commercial magnesium oxide, whereas curcumin in C₂—O—SS—Mg-350-3 h gives 0.106 mg/mg of sorption. The dopamine sorption study is shown in FIG. 10D. Infrared spectroscopy of dopamine, adsorbent, and the 1:1 mixture of dopamine and adsorbent was completed. Adsorbent C₂—O—SS—Mg-350-3 h showed hydroxyl and water groups at higher wavenumbers and MgO and cubic MgO at lower wavenumbers. Dopamine showed hydroxyl peaks at higher wavenumbers and nothing at lower wavenumbers. A very broad and tiny peak was observed in the case of a mixture of adsorbent and dopamine confirming that dopamine is adsorbed on the surface of the adsorbent.

A sucrose sorption study was completed using NMR, since there are no bands in the UV-region (Table 2). Time dependent NMR was recorded, and the intensity of the highest peak was considered as the standard peak. Based on standards, peak amounts of sucrose absorbed were calculated and plotted against time. However, fluctuation in sorption was seen, due to absorption desorption; after 2 h stirring of sugar for sorption this was considered to be a straight line. The maximum sorption of sucrose was calculated to be 1.3 mg/mg of sugar. No effect was seen in the capacity with decreasing the amount of sugar. Lastly, polysaccharide sodium carboxyl methylcellulose was studied, and unfortunately, in this case, no sorption was observed.

TABLE 2
NMR analysis of sucrose adsorption with time

| | | Sucrose left | Amount of | Adsorption |
|---|---|---|---|---|
| Time | NMR | in solution | adsorbed sucrose | capacity |
| (hrs.) | Intensity | (mg) | (mg) | (mg/mg) |
| 0 | 3.297 | 20 | 0 | 0 |
| 2 | 1.275 | 7.734 | 12.266 | 1.2266 |
| 4 | 1.035 | 6.278 | 13.722 | 1.3722 |
| 8 | 1.545 | 9.372 | 10.628 | 1.0628 |
| 20 | 1.366 | 8.286 | 11.714 | 1.1714 |

It is understood that the foregoing detailed description and accompanying examples are merely illustrative and are not to be taken as limitations upon the scope of the disclosure, which is defined solely by the appended claims and their equivalents. Preferred methods and materials are described, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting. Various changes and modifications to the disclosed embodiments will be apparent to those skilled in the art and may be made without departing from the spirit and scope thereof.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

Unless otherwise defined herein, scientific, and technical terms used in connection with the present disclosure shall have the meanings that are commonly understood by those of ordinary skill in the art. The meaning and scope of the terms should be clear; in the event, however of any latent ambiguity, definitions provided herein take precedent over any dictionary or extrinsic definition. Further, unless otherwise required by context, singular terms shall include pluralities and plural terms shall include the singular.

Section headings as throughout the entire disclosure herein are merely for organizational purposes and are not intended to be limiting.

What is claimed is:

1. A method for synthesizing a metal oxide nanomaterial, comprising the steps of:
heating a solution comprising large inverse micelles of a metal chelate in a solvent to a temperature greater than the solvent boiling point to form a dried product; and
calcining the dried product to form the metal oxide nanomaterial.

2. The method of claim 1, wherein heating the solution comprises increasing the temperature of the solution at a rate of about 1° C./min.

3. The method of claim 1, wherein the calcining comprises increasing the temperature of the dried product at a rate of about 5° C./min until a final calcination temperature greater than about 250° C. is reached.

4. The method of claim 1, wherein the final calcination temperature is between about 350° C. and about 500° C.

5. The method of claim 1, wherein the calcining step is carried out for about 1 to about 10 hours.

6. The method of claim 1, further comprising:
mixing the solvent with a metal precursor to form a metal chelate solution; and
adding a surfactant to the metal chelate solution.

7. The method of claim 6, further comprising adding an acid to the metal chelate solution.

8. The method of claim 7, wherein the acid comprises nitric acid.

9. The method of claim 1, wherein the metal is at least one of magnesium, calcium, vanadium, nickel, zinc, zirconium, hafnium, tin, lanthanum, and cerium.

10. The method of claim 9, wherein the metal precursor comprises at least one of a metal oxide, a metal nitrate, and a metal chloride.

11. The method of claim 9, wherein the metal precursor is selected from magnesium oxide, calcium nitrate, vanadium oxide, nickel nitrate, zinc nitrate, zirconium oxide, hafnium chloride, tin chloride, lanthanum oxide, and cerium nitrate.

12. The method of claim 1, wherein the solvent is a diol.

13. The method of claim 12, wherein the diol is ethanediol, a propanediol, a butanediol, a pentanediol, or a combination thereof.

14. The method of claim 6, wherein the solvent is ethylene glycol and the metal precursor is magnesium oxide.

15. The method of claim 6, wherein the surfactant comprises an amphiphilic block copolymer.

16. The method of claim 1, wherein the metal oxide nanomaterial comprises pores with average diameters between about 2 and about 50 nm, comprises pores with total volumes greater than about 0.1 cc/g, has a surface area between about 10 and 200 m²/g, or a combination thereof.

17. A metal oxide nanomaterial comprising:
at least one metal oxide formed by calcining a chelate of at least one metal precursor, wherein the metal oxide nanomaterial has:
pores with average diameters greater than about 2 nm;
pores with total volumes greater than about 0.1 cc/g;
a surface area greater than 10 m²/g; or
a combination thereof.

18. The metal oxide nanomaterial of claim 17, wherein the nanomaterial comprises pores with average diameters greater than about 10 nm, pores with total volumes greater than about 1 cc/g, a surface area greater than about 50 m²/g, or a combination thereof.

19. The metal oxide nanomaterial of claim 18, wherein the metal is magnesium, calcium, vanadium, nickel, zinc, zirconium, hafnium, tin, lanthanum, or cerium.

20. A mesoporous metal oxide nanomaterial comprising magnesium oxide having a surface area greater than 150 m²/g and pores with average diameters greater than 30 nm, wherein the pores have total volumes greater than 1.0 cc/g.
